(19) United States
(12) Patent Application Publication
(10) Pub. No.: US 2023/0239736 A1
(43) Pub. Date: Jul. 27, 2023

(54) METHOD AND APPARATUS FOR SUPPORTING CHANGE OF NETWORK SLICE IN WIRELESS COMMUNICATION SYSTEM

(71) Applicant: SAMSUNG ELECTRONICS CO., LTD., Suwon-si (KR)

(72) Inventors: Dongeun Suh, Suwon-si (KR); Hoyeon Lee, Suwon-si (KR)

(21) Appl. No.: 18/160,175

(22) Filed: Jan. 26, 2023

(30) Foreign Application Priority Data
Jan. 26, 2022 (KR) 10-2022-0011561
Aug. 2, 2022 (KR) 10-2022-0096127
Oct. 4, 2022 (KR) 10-2022-0126493

(51) Int. Cl. H04W 28/06

(52) U.S. Cl. CPC H04W 28/06

(57) ABSTRACT

The disclosure relates to a 5G or 6G communication system for supporting a higher data transmission rate. According to various embodiments, a method performed by an access mobility and management function (AMF) node in a mobile communication system, the method comprising: receiving, from a slice availability check function (SACF) node, a notification message including information on an unavailable slice; receiving, from a network data analysis function (NWDAF) node, information on a protocol data unit (PDU) session; determining, based on the notification message and the information on the PDU session, a target slice and at least one PDU session requiring a change of slice; and transmitting, to a session management function (SMF) node, a request message for changing the slice of the at least one PDU session to the target slice.

### CROSS-REFERENCE TO RELATED APPLICATIONS

This application is based on and claims priority under 35 U.S.C. § 119 to Korean Patent Application No. 10-2022-0011561 filed on Jan. 26, 2022, Korean Patent Application No. 10-2022-0096127 filed on Aug. 2, 2022, and Korean Patent Application No. 10-2022-0126493 filed on Oct. 4, 2022, in the Korean Intellectual Property Office, the disclosure of which is incorporated by reference herein in their entirety.

### BACKGROUND

### 1. Field

The present disclosure relates to a method and apparatus for supporting a change of a network slice in a wireless communication system.

Specifically, the present disclosure relates to a method and apparatus for determining a target slice and moving protocol data unit (PDU) sessions belonging to a specific slice to the target slice in a wireless communication.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

As described above, with the development of the wireless communication system, various 5G network entities belonging to a network slice may be congested for each protocol data unit (PDU) session, or the use of a specific slice may be temporarily or permanently suspended for an operational cause. In this case, there is a need for a method of smoothly providing efficiency of an application. In particular, there is a need for a method of determining a target slice and a method of moving PDU sessions belonging to a specific slice to the target slice, upon discovering a situation in which performance of the application deteriorates and thus the use of a corresponding slice may be temporarily or permanently suspended.

### SUMMARY

Based on the aforementioned discussion, the disclosure is to provide an apparatus and method capable of smoothly providing efficiency of an application in a wireless communication system.

In addition, the present disclosure provides an apparatus and method for moving protocol data unit (PDU) sessions belonging to a specific slice to a target slice, upon discovering a situation in which performance of an application deteriorates and thus the use of a corresponding slice may be temporarily or permanently suspended.

According to embodiments of the disclosure, a method performed by an access mobility and management function (AMF) node in a mobile communication system, the method comprising: receiving, from a slice availability check function (SACF) node, a notification message including information on an unavailable slice; receiving, from a network data analysis function (NWDAF) node, information on a protocol data unit (PDU) session; determining, based on the notification message and the information on the PDU session, a target slice and at least one PDU session requiring a change of slice; and transmitting, to a session management function (SMF) node, a request message for changing the slice of the at least one PDU session to the target slice.

According to embodiments of the disclosure, a method performed by a session management function (SMF) node in a mobile communication system, the method comprising: receiving, from an access mobility and management function (AMF) node, a request message for changing a slice of at least one protocol data unit (PDU) session; and transmitting, to the AMF node, information on a change of the at least one PDU session based on the request message, wherein the request message includes information on the target slice and an indication indicating a changing method for the at least one PDU session, and wherein the changing method comprises at least one of a first method of modifying a context of the at least one PDU session, a second method of establishing one or more PDU sessions after releasing the at least one PDU session, or a third method of releasing the at least one PDU session after establishing the one or more PDU sessions.

According to embodiments of the disclosure, an access mobility and management function (AMF) node in a mobile communication system, the AMF comprising a controller, wherein the controller is configured to: receive, from a slice availability check function (SACF) node, a notification message including information on an unavailable slice, receive, from a network data analysis function (NWDAF) node, information on a protocol data unit (PDU) session, determine, based on the notification message and the information on the PDU session, a target slice and at least one PDU session requiring a change of slice, and transmit, to a session management function (SMF) node, a request message for changing the slice of the at least one PDU session to the target slice.

According to embodiments of the disclosure, a session management function (SMF) node in a mobile communication system, the SMF comprising a controller, wherein the controller is configured to: receive, from an access mobility and management function (AMF) node, a request message for changing a slice of at least one protocol data unit (PDU) session, and transmit, to the AMF node, information on a change of the at least one PDU session based on the request message, wherein the request message includes information on the target slice and an indication indicating a changing method for the at least one PDU session, and wherein the changing method comprises at least one of a first method of modifying a context of the at least one PDU session, a second method of establishing one or more PDU sessions after releasing the at least one PDU session, or a third method of releasing the at least one PDU session after establishing the one or more PDU sessions.

Various embodiments of the disclosure may provide an apparatus and method capable of effectively providing a service in a wireless communication system.

Advantages acquired in the disclosure are not limited to the aforementioned advantages, and other advantages not mentioned herein may be clearly understood by those skilled in the art to which the disclosure pertains from the following descriptions.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a communication network including core network entities in a wireless communication system according to various embodiments of the present disclosure;

FIG. 2A illustrates a wireless environment including a core network in a wireless communication system according to various embodiments of the present disclosure;

FIG. 2B illustrates a structure of a core network entity in a wireless communication system according to various embodiments of the present disclosure;

FIG. 2C illustrates a structure of a UE in a wireless communication system according to various embodiments of the present disclosure;

FIG. 3 illustrates a signaling flow for requesting to move a slice according to various embodiments of the present disclosure;

FIG. 4 illustrates a flowchart for an operation of an AMF for requesting to move a slice according to various embodiments of the present disclosure;

FIG. 5 illustrates a signaling flow for moving a slice for a session according to various embodiments of the present disclosure;

FIG. 6 illustrates a flowchart for an operation of an AMF for moving a slice for a session according to various embodiments of the present disclosure; and

FIG. 7 illustrates a flowchart for an operation of an SMF for moving a slice for a session according to various embodiments of the present disclosure.

### DETAILED DESCRIPTION

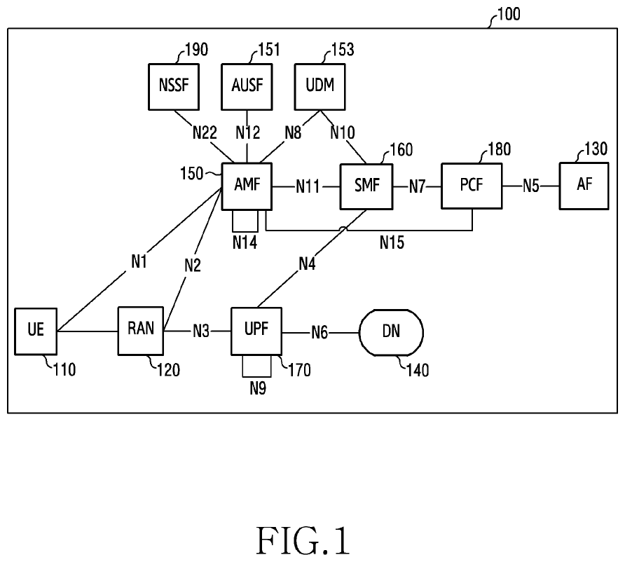

FIGS. 1 through 7, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Terms used in the disclosure are for the purpose of describing particular embodiments only and are not intended to limit other embodiments. A singular expression may include a plural expression unless there is a contextually distinctive difference. All terms (including technical and scientific terms) used herein have the same meaning as commonly understood by those ordinarily skilled in the art disclosed in the disclosure. It will be further understood that terms, such as those defined in commonly used dictionaries, should be interpreted as having a meaning that is consistent with their meaning in the context of the relevant art, and will not be interpreted in an idealized or overly formal sense unless expressly so defined herein. Optionally, the terms defined in the disclosure should not be interpreted to exclude the embodiments of the disclosure.

A hardware-based approach is described for example in the various embodiments of the disclosure described hereinafter. However, since the various embodiments of the disclosure include a technique in which hardware and software are both used, a software-based approach is not excluded in the embodiments of the disclosure.

Hereinafter, the disclosure relates to an apparatus and method for changing a slice for a session in a wireless communication system. Specifically, the disclosure describes a technique for determining a target slice and moving protocol data unit (PDU) sessions belonging to a specific slice to the target slice in a wireless communication system.

Various embodiments of the disclosure allow an access and mobility management function (AMF) to receive information on a specific slice required to move in a 5th generation (5G) system, and to perform proper processing for the slice. In addition, the AMF may configure an optimal target slice by considering a requirement, slice state information, or the like for the PDU session.

In addition, an apparatus and method according to various embodiments of the disclosure allow an AMF to determine a slice movement method in consideration of a requirement for a PDU session and a cause of requiring a slice movement, or the like, thereby ensuring user experience and network control efficiency. Various embodiments of the disclosure allow a session management function (SMF) to maintain session continuity and to move a PDU session to a target slice.

In the following description, terms referring to a signal, a channel, control information, network entities, and components of a device, or the like are used for convenience of explanation. Therefore, the disclosure is not limited to the terms described below, and thus other terms having the same technical meaning may also be used.

In addition, although the disclosure describes various embodiments by using terms used in some communication standards (e.g., 3rd generation partnership project (3GPP)), this is for exemplary purposes only. Various embodiments of the disclosure may be easily modified and applied to other communication systems.

FIG. 1 illustrates a communication network including core network entities in a wireless communication system according to various embodiments of the present disclosure. A 5G mobile communication network may include a 5G user equipment (UE) 110, a 5G radio access network (RAN) 120, and a 5G core network.

The 5G core network may include network functions such as an access and mobility management function (AMF) 150 providing a mobility management function, a session management function (SMF) 160 providing a session management function, a user plane function (UPF) 170 performing a data forwarding role, a policy control function (PCF) 180 providing a policy control function, a unified data management (UDM) 153 providing a data management function for subscriber data, policy control data, etc., or a unified data repository (UDR) storing data of various network functions.

Referring to FIG. 1, the UE 110 may perform communication through a radio channel. i.e., an access network, established with a base station (e.g., eNB, gNB). In some embodiments, the UE 110 is a device used by a user, and may be a device configured to provide a user interface (UI). As an example, the UE 110 may be a UE equipped in a vehicle for driving. In some other embodiments, the UE 110 may be a device which performs machine type communication (MTC) operated without user involvement, or may be an autonomous vehicle. In addition to an electronic device, the UE may also be referred to as a “terminal,” a “vehicle terminal,” a “user equipment (UE),” a “mobile station,” a “subscriber station,” a “remote terminal,” a “wireless terminal,” a “user device,” or other terms having equivalent technical meaning. As a terminal, a customer-premises equipment (CPE) or a dongle-type terminal may be used in addition to the UE. The CPE is coupled to an NG-RAN node similarly to the UE, and may provide a network to other communication equipment (e.g., a laptop).

Referring to FIG. 1, the AMF 150 provides a function for access and mobility management in units of the UE 110, and one UE 110 may be coupled by default to one AMF 150. Specifically, the AMF 150 may perform at least one of functions of signaling between core network nodes for mobility between 3GPP access networks, an interface (N2 interface) between radio access networks (e.g., the 5G RANs 120), NAS signaling with the UE 110, identification of the SMF 160, and providing session management (SM) message forwarding between the UE 110 and the SMF 160. Some or all functions of the AMF 150 may be supported in a single instance of one AMF 150.

Referring to FIG. 1, the SMF 160 provides a session management function. When the UE 110 has multiple sessions, the SMF 160 which manages a session may be different for each session. Specifically, the SMF 160 may perform at least one of functions of session management (e.g., establishing, modifying, and releasing of a session, including maintaining of a tunnel between the UPF 170 and the access network node), selection and control of a user plane (UP) function, traffic steering configuration for routing traffic from the UPF 170 to a proper destination, termination of an SM part of a non-access stratum (NAS) message, downlink data notification (DDN), and an initiator of AN-specific SM information (forwarding to the access network through N2 via the AMF 150. Some or all functions of the SMF 160 may be supported in a single instance of one SMF 160.

In the 3GPP system, conceptual links connecting NFs in the 5G system may be referred to as a reference point. The reference point may also be referred to as an interface. The reference point included in a 5G system architecture represented across FIG. 1 to FIG. 7 is exemplified as follows:
N1: reference point between the UE 110 and the AMF 150;
N2: reference point between the (R)AN 120 and the AMF 150;
N3: reference point between the (R)AN 120 and the UPF 170;
N4: reference point between the SMF 160 and the UPF 170;
N5: reference point between the PCF 180 and the AF 130;
N6: reference point between the UPF 170 and the DN 140;
N7: reference point between the SMF 160 and the PCF 180;
N8: reference point between the UDM 153 and the AMF 150;
N9: reference point between the two core UPFs 170;
N10: reference point between the UDM 153 and the SMF 160;
N11: reference point between the AMF 150 and the SMF 160;
N12: reference point between the AMF 150 and an authentication server function (AUSF) 151;
N13: reference point between the UDM 153 and the AUSF 151;
N14: reference point between the two AMFs 150; and
N15: reference point between the PCF 180 and the AMF 150 in case of non-roaming scenario, reference point between the PCF 180 and the AMF 150 in a visited network in case of roaming scenario.

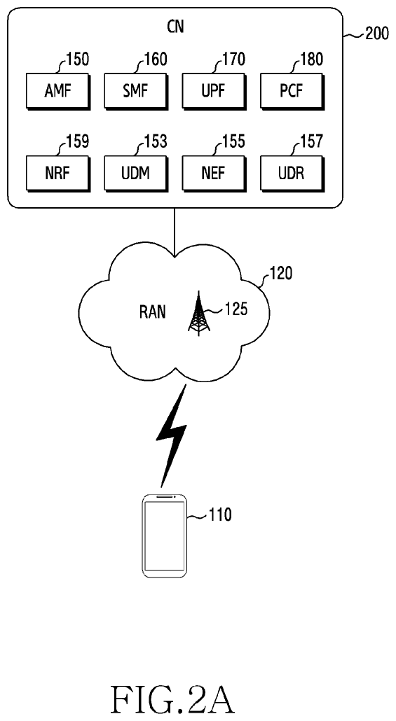

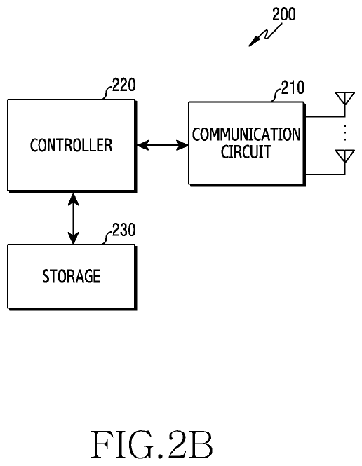

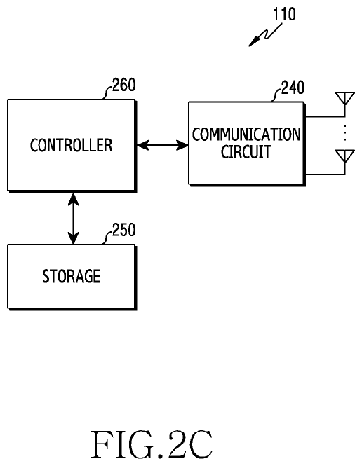

FIG. 2A illustrates a wireless environment including a core network (CN) 200 in a wireless communication system according to various embodiments of the present disclosure.

Referring to FIG. 2A, the wireless communication system includes an RAN 120 and the CN 200.

The RAN 120 is a network directly coupled to a user device, e.g., a UE 110, and is an infrastructure which provides radio access to the UE 110. The RAN 120 includes a set of a plurality of base stations including a base station 125. The plurality of base stations may perform communication through a mutually constructed interface. At least some of the interfaces between the plurality of base stations may be wired or wireless interfaces. The base station 125 may have a structure divided into a central unit (CU) and a distributed unit (DU). In this case, one CU may control a plurality of DUs. In addition to the base station, the base station 125 may be referred to as an “access point (AP),” a “next generation node B (gNB),” a “5th generation node (5G node),” a “wireless point,” a “transmission/reception point (TRP),” or other terms having equivalent technical meaning. The UE 110 accesses the RAN 120 and communicates with the base station 125 through a radio channel. In addition to the terminal, the UE 110 may be referred to as a “user equipment (UE),” a “mobile station,” a “subscriber station,” a “remote terminal,” a “wireless terminal,” a “user device,” or other terms having equivalent technical meaning.

As a network which manages the entire system, the CN 200 controls the RAN 120 and processes data and control signals transmitted/received for the UE 110 through the RAN 120. The CN 200 performs various functions such as user plane and control plane control, mobility processing, subscriber information management, charging, interworking with other types of systems (e.g., long term evolution (LTE) systems), or the like. In order to perform the aforementioned various functions, the CN 200 may include a plurality of functionally separated entities having different network functions (NFs). For example, the CN 200 may include an access and mobility management function (AMF) 150, a session management function (SMF) 160, a user plane function (UPF) 170, a policy and charging function (PCF) 180, a network repository function (NRF) 159, a user data management (UDM) 153, a network exposure function (NEF) 155, and a unified data repository (UDR) 157.

The UE 110 is coupled to the RAN 120 and accesses the AMF 150 which performs a mobility management function of the CN 200. The AMF 150 is a function or device responsible for both the access of the RAN 120 and mobility management of the UE 110. The SMF 160 is an NF which manages a session. The AMF 150 is coupled to the SMF 160, and the AMF 150 routes a session-related message for the UE 110 to the SMF 160. The SMF 160 coupled to the UPF 170 allocates a user plane resource to be provided to the UE 110, and establishes a tunnel for transmitting data between the base station 125 and the UPF 170. The PCF 180 controls information related to a policy and charging for a session used by the UE 110. The NRF 159 stores information on NFs installed in a mobile communication operator's network and performs a function of notifying the stored information. The NRF 159 may be coupled to all NFs. When each NF starts operating in the operator's network, it is notified to the NRF 159 that a corresponding NF is operating in the network by registering to the NRF 159. The UDM 153 is an NF which performs a role similar to a home subscriber server (HSS) of a 4G network, and stores subscription information of the UE 110 or context used by the UE 110 in the network.

The NEF 155 serves to couple a 3rd party server and the NF in the 5G mobile communication system. It also serves to provide data to the UDR 157 or serves to update or obtain data. The UDR 157 performs a function of storing subscription information of the UE 110, storing policy information, storing data exposed to the outside, or storing information necessary for a 3rd party application. In addition, the UDR 157 also serves to provide stored data to other NFs.

FIG. 2B illustrates a structure of a core network entity in a wireless communication system according to various embodiments of the present disclosure. The exemplary structure 200 of FIG. 2B may be understood as a structure of a device which performs at least one function among the functions 150, 153, 155, 157, 160, 170, 180, and 190 of FIG. 1. Hereinafter, the term “ . . . unit,” “ . . . device,” or the like implies a unit of processing at least one function or operation, and may be implemented in hardware or software or in combination of the hardware and the software.

Referring to FIG. 2B, a core network entity includes a communication circuit 210, a storage 230, and a storage 220.

The communication circuit 210 provides an interface for preforming communication with different nodes in a network. That is, the communication circuit 210 converts a bit-stream transmitted from the core network entity to a different device, and converts a physical signal received from the different device into a bit-stream. That is, the communication circuit 210 may transmit and receive a signal. Accordingly, the communication circuit 210 may be referred to as a transmitter, a receiver, or a transceiver. In this case, the communication circuit 210 may allow the core network entity to communicate with other devices or systems via a backhaul connection (e.g., a wired backhaul or a wireless backhaul).

The storage 230 stores data such as a basic program, application program, configuration information, or the like for an operation of the core network entity. The storage 230 may be constructed of a volatile memory, a non-volatile memory, or a combination of the volatile memory and the non-volatile memory. In addition, the storage 230 may provide the stored data according to a request of the controller 220.

The controller 220 may control overall operations of the core network entity. For example, the controller 220 transmits and receives a signal via the communication circuit 210. In addition, the controller 220 writes data to the storage 230 and reads the data. To this end, the controller 220 may include at least one processor. According to various embodiments, the controller 220 may provide control to perform synchronization using a wireless communication network. For example, the controller 220 may provide control to perform operations according to various embodiments described below.

FIG. 2C illustrates a structure of a UE in a wireless communication system according to various embodiments of the disclosure. The structure exemplified in FIG. 2C may be understood as a structure of the UE 110. Hereinafter, the term “ . . . unit,” “ . . . device,” or the like implies a unit of processing at least one function or operation, and may be implemented in hardware or software or in combination of the hardware and the software.

Referring to FIG. 2C, the UE includes a communication circuit 240, a storage 250, and a controller 260.

The communication circuit 240 performs functions for transmitting and receiving a signal through a radio channel. For example, the communication circuit 240 performs a function of conversion between a baseband signal and a bit-stream according to a physical layer standard of a system. For example, in data transmission, the communication circuit 240 generates complex symbols by coding and modulating a transmission bit-stream. In addition, in data reception, the communication circuit 240 restores a received bit-stream by demodulating and decoding a baseband signal. In addition, the communication circuit 240 up-converts a baseband signal into a radio frequency (RF) signal and thereafter transmits it through an antenna, and down-converts an RF signal received through the antenna into a baseband signal. For example, the communication circuit 250 may include a transmission filter, a reception filter, an amplifier, a mixer, an oscillator, a digital to analog converter (DAC), an analog to digital converter (ADC), or the like.

In addition, the communication circuit 240 may include a plurality of transmission/reception paths. Further, the communication circuit 240 may include at least one antenna array constructed of a plurality of antenna elements. From a hardware aspect, the communication circuit 240 may be constructed of a digital unit and an analog unit (e.g., a radio frequency integrated circuit (RFIC)). Herein, the digital circuit and the analog unit may be implemented as one package. In addition, the communication circuit 240 may include a plurality of RF chains. Further, the communication circuit 240 may perform beamforming.

The communication circuit 240 transmits and receives a signal as described above. Accordingly, the entirety or part of the communication circuit 240 may be referred to as a “transmitter,” a “receiver,” or a “transceiver,” In addition, in the following description, transmission and reception performed through a radio channel are used to imply that the aforementioned processing is performed by the communication circuit 240.

The storage 250 stores data such as a basic program, application program, configuration information, or the like for an operation of the UE. The storage 250 may be constructed of a volatile memory, a non-volatile memory, or a combination of the volatile memory and the non-volatile memory. In addition, the storage 250 may provide the stored data according to a request of the controller 260.

The controller 260 controls overall operations of the UE. For example, the controller 260 transmits and receives a signal via the communication circuit 240. In addition, the controller 260 writes data to the storage 250 and reads the data. Further, the controller 260 may perform functions of a protocol stack required in a communication standard. To this end, the controller 260 may include at least one processor or micro-processor, or may be part of the processor. In addition, part of the communication circuit 240 and the controller 260 may be referred to as a communication processor (CP). According to various embodiments, the controller 260 may provide control to perform synchronization using a wireless communication network. For example, the controller 260 may control the UE to perform operations according to various embodiments described below.

In the following description, a term for identifying an access node, terms referring to network entities, terms referring to messages, a term referring to an interface between network entities, terms referring to various pieces of identification information, or the like are exemplified for convenience of explanation. Therefore, without being limited to the terms used in the disclosure, other terms having equivalent technical meanings may also be used.

For convenience of description below, the disclosure uses terms and names defined in 5G system (5GS) and new radio (NR) standards which are the latest standards defined in the 3GPP organization among currently existing communication standards. However, the disclose is not limited by the terms and names, and may also be equally applied to a wireless communication network conforming to other standards. In particular, the disclosure may also be applied to a 3GPP 5G mobile communication standard (e.g., 5GS and NR).

In the 5G system, there is a technology called a session and service continuity (SSC) mode which supports session continuity for the purpose of improving user's quality-of-experience (QoE) or supporting a mission critical service. The SSC may be configured in three modes. Among them, an SSC mode 3 may be referred to as make-before-break. Upon determining that there is a need to release an SSC mode 3 PDU session being used by the UE 110, the network 200 may establish a new PDU session which may replace a corresponding PDU session. In addition, the network 200 may support session continuity by releasing the existing PDU session. Before the existing PDU session is released, the UE 110 may transfer traffic flows being transmitted/received through the existing PDU session to the new PDU session, thereby maintaining the session continuity.

In the 5G system, a network slicing technology represents a technology and structure which enable access to several independent logical networks, virtualized in one physical network. A network operate may provide a service by configuring a virtual end-to-end network called a network slice in order to satisfy a specialized requirement of a service/application. The network slice may be identified by an identifier called single-network slice selection assistance information (S-NSSAI). The network operator may provide slice(s) to a UE to receive a service.

Specifically, in the 5G system, when registered to a network, the UE 110 may transmit identifier information (for example, requested S-NSSAIs) for to-be-requested network slices to the AMF 150. Upon receiving the identifier information, the AMF 150 may provide the UE 110 with information (for example, allowed NSSAI) on network slices usable by the UE 110 by considering requested S-NSSAIs, subscriber information, or the like. Even if the UE 110 does not provide the information on the requested slices, the AMF 150 may provide the UE 110 with the allowed NSSAI. In this case, the allowed NSSAI may include information on default configuration slices (for example, default configuration NSSAI) and information on slices configured by default (for example, default subscribed S-NSSAIs) among subscriber slices included in UE subscriber information.

If the allowed NSSAI does not include any slice (for example, if the default configured NSSAI and the default subscribed S-NSSAIs are not present or unavailable), the AMF 150 may transmit a network registration reject message to the UE 110 together with a cause code indicating that the registration is rejected due to an absence of an available slice.

Meanwhile, when the UE 110 intends to include any slice in the allowed NSSAI, an admission control (network slice admission control (NSAC)) procedure and authentication (network slice-specific authentication and authorization (NSSAA)) procedure for a corresponding slice may be performed. In the NSAC procedure, based on the number of UEs currently registered in a specific slice and the maximum number of registered UEs allocated in the slice, whether to accept the slice may be determined (for example, whether the slice is included in the allowed NSSAI is determined). In the NSSAA procedure, an authentication procedure may be performed with AAA-S, which is a server for authenticating the slice through, for example, an NSSAA function (NSSAAF), based on credential information on the slice of the UE. In this case, whether to accept the slice may be determined by considering an authentication result (for example, whether the slice is included in the allowed NSSAI is determined).

Meanwhile, the UE 110 may select one of allowed slices, in order to transmit and receive data to the specific data network (DN) 140 through the allowed NSSAIs. In addition, the UE 110 may request a specific data network name (DNN) to generate a packet data unit (PDU) session in a corresponding slice, and may transmit and receive data through the generated PDU session. The PDU session may be constructed of several traffic flows. The traffic flow may be constructed of two types of a guaranteed bitrate quality-of-service flow (GBR QoS flow) and a non-GBR QoS flow.

On the other hand, in the 5G system, a congestion situation for a slice may occur or an operational cause for a specific slice (for example, operations, administration and maintenance (OAM)) may occur. Due to the congestion situation or the operational cause, a situation may occur in which some of slices which have already been used by the UE 110 having a PDU session established are not available, or even if they are available, performance degradation occurs. In this case, the 5G system needs a method for moving the existing PDU sessions belonging to a corresponding slice to another slice (for example, a target slice). Herein, it is necessary to adaptively determine slice(s) to be moved and target slice(s) for each UE, and it is necessary to ensure session continuity.

According to various embodiments of the disclosure, a method of discovering a situation in which application or service performance deteriorates is provided when congestion has occurred among various 5G network entities belonging to a network slice for each PDU session in the 5G system (for example, a network slice congestion situation) or when the use of specific slice(s) may be temporarily or permanently suspended due to an operational cause (for example, an OAM case). In addition, a method of determining a target slice when the use of the slice(s) may be temporarily or permanently suspended and a method of moving all or some of PDU sessions belonging to specific slice(s) to a target slice are provided.

According to various embodiments of the disclosure, when the use of slice(s) may be temporarily or permanently suspended, a slice availability check network function (SACNF) 310 may determine such a situation. The SACNF 310 may inform the AMF 150 of information on slices which need to be moved, and the AMF 150 may determine a target slice and PDU sessions which need to be moved.

According to an embodiment, the AMF 150 may request the SMF 160 to move some or all of sessions established through an unavailable slice to the target slice. The request for the movement may be requested in the following three types.

In one embodiment of using the existing session (for example, context modification method), only context of a corresponding session may be updated (for example, only slice information may be changed to a target slice). A session context update procedure may be performed in the AMF 150, the SMF 160, the RAN 120, the UE 110, and the UPF 170. According to an embodiment, the method 1) may be used to support continuity by directly using the existing session.

In one embodiment of generating anew session after releasing the existing session (for example, break-before-make), a new PDU session to a target slice may be generated by releasing the existing session. According to an embodiment, since a traffic flow sent to the existing session may be sent through a new PDU session, continuity may be supported.

In one embodiment of releasing the existing session after generating anew session (for example, make-before-break), since a new PDU session to a target slice may be generated, and a traffic flow sent to the existing session may be transmitted through the new PDU session, continuity may be supported. According to an embodiment, the existing session may be released after a new session is established.

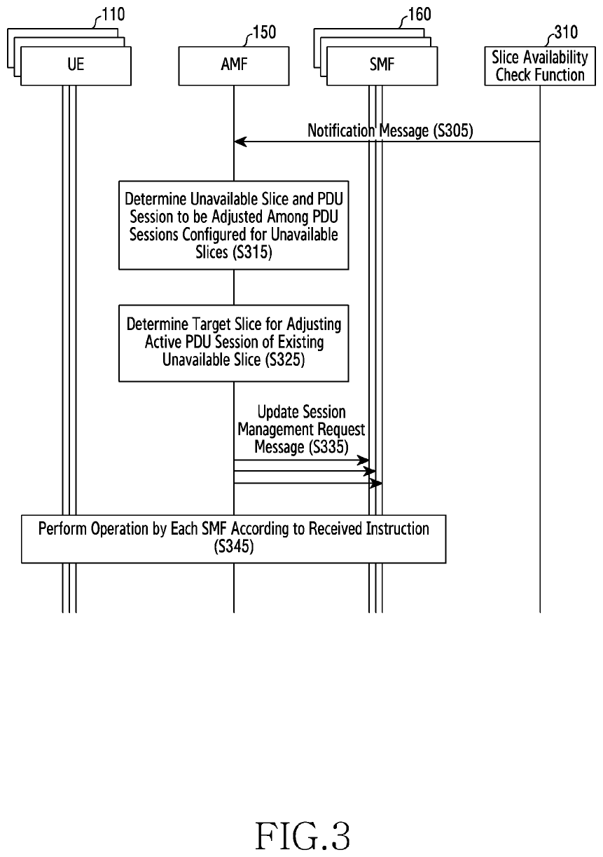

FIG. 3 illustrates a signaling flow for requesting to move a slice according to various embodiments of the present disclosure. Specifically, FIG. 3 illustrates a procedure in which the AMF 150 receives information related to an unavailable slice through the slice availability check function (SACF) 310, determines a target slice for a session, and requests to move to the target slice. Referring to FIG. 3, the SACF may also be referred to as a slice availability check network function (SACNF).

According to an embodiment, the SACF 310 may be located in at least any one entity(or include at least any one entity) among the AMF 150, the application function (AF) 130, the radio access network (RAN) 120, the network slice selection function (NSSF) 190, a network data analytics function (NWDAF) (not shown), an OAM (not shown in FIG. 3), the PCF 180, and the UDM 153. The OAM may be one of entities (e.g., a network slice management function (NSMF) and communication service management function (CSMF) belonging to operation support systems/business support systems (OSS/BSS), or a network function virtualization orchestrator (NFVO) belonging to management and orchestration (MANO)) for managing a network resource (e.g., resource monitoring and resource assignment for NFs, management of an NF life cycle, or the like). However, according to various embodiments of the disclosure, without being limited thereto, the SACF 310 may exist on the network as a separate entity.

In step S305, the AMF 150 may receive a notification message from the SACF 310.

Referring to step S315, the AMF 150 may determine slice(s) unavailable due to OAM or congestion, based on information provided by a network manager or configuration information or based on the notification message received from the SACF 310. According to an embodiment, the notification message received from the SACNF 310 may include the following information.

“Unavailable slice(s),” “list of TA(tracking area)(s),” “cause=congestion or OAM or performance issue,” “slice change required information”

However, according to various embodiments of the disclosure, the notification message received by the AMF 150 is not limited thereto, and may include information in addition to the aforementioned information.

“Unavailable slice(s)” may include identifier information for slice(s) not available (or required to move). “List of tracking areas (TAs)” may include information indicating a region in which the unavailable slice is not available. “Cause” may include information on a cause that slice(s) are not available (for example, congestion occurrence, OAM, or the like). According to an embodiment, slice change required information may include at least one of an indicator indicating a slice change for unavailable slice(s) and target slice information for each slice belonging to the unavailable slice(s).

In addition, referring to step S315, if the “cause” of the message received from the SACF 310 is congestion among PDU sessions belonging to the determined unavailable slice(s), the AMF 150 may receive experience data resulted from congestion control for each UE for PDU sessions belonging to the determined unavailable slice(s) for each slice (e.g., S-NSSAI) and data network name (DNN) from network data analytics. The AMF 150 may determine PDU sessions to be moved to another slice, based on the received experience data.

Referring to step S325, upon receiving the message from the SACF 310 in step S315, the AMF 150 may start a procedure of moving all or some of PDU sessions belonging to the unavailable slice(s) (for example, the sessions determined in step S315) to target slice(s).

According to an embodiment, the AMF 150 may release the existing session established with the unavailable slice. In order to replace the released session, the AMF 150 may request to generate a new PDU session to the target slice (e.g., may change a PDU session ID). According to an embodiment, the AMF 150 may transmit a request to modify only information on a slice of a corresponding session to the target slice through modification on the existing session, without having to release the existing session. According to an embodiment, upon determining the target slice, the AMF 150 may consider slice information and allowed NSSAI supported by the SMF 160 which manages a corresponding session.

According to an embodiment, upon determining the target slice, the AMF 150 may request a corresponding NF for the following information and receive the information, and then may consider this in the determining of the target slice.

“Per-slice load information from NWDAF,” “the number of registered UEs for each slice requested/received from network slice admission control function (NSACF),” “the number of PDU sessions for each slice),” “slice change required information received from SACF,” or the like.

Referring to step S335, the AMF 150 may transmit to the SMF 160 a request message for moving PDU sessions determined to move the slice in step S315 to the target slice determined in step S325. The request message transmitted by the AMF 150 may be referred to as an update session management request message. A message format of the request message transmitted by the AMF 150 may use at least one of “Nsmf_PDUSession_UpdateSMContext Request,” “Nsmf_PDUSession_ReleaseSMContext Request,” “Nsmf_PDUSession_UpdateSMContext Request,” and “Nsmf_PDUSession_ContextPushRequest.” According to an embodiment, the request message transmitted by the AMF 150 may include at least one of the following pieces of information.

“SM Context ID or PDU session ID,” “indication,” “Cause=OAM or congestion,” and “target slice information.”

However, according to various embodiments of the disclosure, the request message transmitted by the AMF 150 is not limited thereto, and may include information in addition to the aforementioned information.

“SM context ID” may be an identifier indicating per-session information. “Indication” may be set to at least one of three types of “context modification,” “release with make-before-break,” and “session release with break-before-make.”

According to an embodiment, the AMF 150 may not release the existing session, and may set “indication” to “context modification” when it is requested to modify only information on a slice of a corresponding session to the target slice through modification on the existing session.

According to an embodiment, when a PDU session corresponding to an SM context ID or a PDU session ID is an SSC mode 1 PDU session, the AMF 150 may set “indication” included in a message transmitted to the SMF 160 to “context modification.”

According to an embodiment, the AMF 150 may release the existing session established with an unavailable slice, and when it is requested to generate a new PDU session to a target slice for replacing a corresponding session, may set “indication” to “indication session release with break-before-make” (or “session release with break-before-make”).

According to an embodiment, before the existing session established with the unavailable slice is released, when it is requested to generate and then release a new PDU session to the target slice for replacing a corresponding session, the AMF 150 may set “indication” to “indication session release with make-before-break” (or “session release with make-before-break”).

Referring to step S345, according to an embodiment, when “indication” of the message received in step S335 is “context modification, the SMF 160 which has received the request message from the AMF may start a procedure of modifying information on a slice with which a corresponding session is currently established to a target slice, in context information on a PDU session corresponding to a “SM context ID” or “PDU session ID” of a message received in step S335 and stored in a 5G system (for example, the SMF 160, the AMF 150, the UPF 170, and the UE 110).

According to an embodiment, when the “indication” of the message received in step S335 is “release with break-before-make,” the SMF 160 may perform a procedure for generating a new PDU session to a target slice for replacing a corresponding session, after releasing a PDU session corresponding to an “SM context ID” or “PDU session ID” of the message received in step S335.

According to an embodiment, when the “indication” of the message received in step S335 is “release with make-before-break,” the SMF 160 may perform a procedure for generating and then releasing a new PDU session to a target slice for replacing a corresponding session, before releasing a PDU session corresponding to an “SM context ID” or “PDU session ID” of the message received in step S335.

According to various embodiments of the disclosure, the SMF 160 which has performed a corresponding procedure may inform the AMF 150 of a processing result.

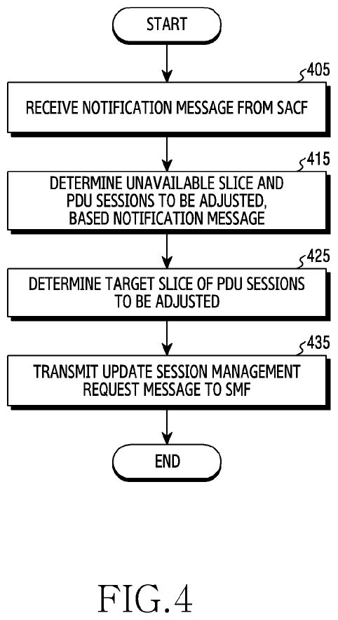

FIG. 4 illustrates a flowchart for an operation of the AMF 150 for requesting to move a slice according to various embodiments of the present disclosure. Specifically, an operational flow of the AMF 150 illustrated in FIG. 4 may operate based on the signal flow illustrated in FIG. 3.

In step 405, the AMF 150 may receive a notification message from the SACF 310. According to an embodiment, the SACF 310 may be referred to as the SACNF 310. According to an embodiment, the SACF 310 may be located in at least any one entity among the AMF 150, the application function (AF) 130, the radio access network (RAN) 120, the network slice selection function (NSSF) 190, the network data analytics function (NWDAF) (not shown), the operations, administration and maintenance (OAM) (not shown), the PCF 180, and the UDM 153. However, according to various embodiments of the disclosure, without being limited thereto, the SACF 310 may be constructed separately as an entity in addition to the above example.

According to an embodiment, the following information may be included in a notification message received from the SACF 310.

“Unavailable slice(s),” “list of TA(tracking area)(s),” “cause=congestion or OAM or performance issue,” “slice change required information.”

However, according to various embodiments of the disclosure, the notification message received by the AMF 150 is not limited thereto, and may include information in addition to the aforementioned information.

“Unavailable slice(s)” may include identifier information for slice(s) not available (or required to move). “List of tracking areas(TAs)” may include information indicating a region in which the unavailable slice is not available. “Cause” may include information on a cause that slice(s) are not available (for example, congestion occurrence, OAM, or the like).

According to an embodiment, slice change required information may include at least one of an indicator indicating a slice change for unavailable slice(s) and target slice information for each slice belonging to the unavailable slice(s).

In step 415, the AMF 150 may determine an unavailable slice and PDU sessions to be changed, based on the received notification message. According to an embodiment, the AMF 150 may determine unavailable slice(s) due to OAM or congestion, based on information provided by a network manager or configuration information or based on the notification message received from the SACF 310. According to an embodiment, if the “cause” of the message received from the SACF 310 is congestion among PDU sessions belonging to the determined unavailable slice(s), the AMF 150 may receive experience data resulted from congestion control for each UE for PDU sessions belonging to the determined unavailable slice(s) for each slice (e.g., S-NSSAI) and data network name (DNN) from network data analytics. The AMF 150 may determine PDU sessions to be moved to another slice, based on the received experience data.

In step 425, the AMF 150 may determine target slice(s) of PDU sessions to be changed. According to an embodiment, upon receiving a message from the SACF 310, the AMF 150 may start a procedure of moving all or some of PDU sessions belonging to the unavailable slice(s) (for example, the sessions determined in step S415) to target slice(s).

According to an embodiment, the AMF 150 may release the existing session established with the unavailable slice. In order to replace the released session, the AMF 150 may request to generate a new PDU session to the target slice (for example, may change a PDU session ID). According to an embodiment, the AMF 150 may transmit a request to modify only information on a slice of a corresponding session to the target slice through modification on the existing session, without having to release the existing session. According to an embodiment, upon determining the target slice, the AMF 150 may consider slice information and allowed NSSAI supported by the SMF 160 which manages a corresponding session.

According to an embodiment, upon determining the target slice, the AMF 150 may request a corresponding NF for the following information and receive the information, and then may consider this in the determining of the target slice.

“Per-slice load information from NWDAF,” “the number of registered UEs for each slice requested/received from network slice admission control function (NSACF),” “the number of PDU sessions for each slice),” or the like.

Referring to step S435, the AMF 150 may transmit to the SMF 160 an update session management request message. According to an embodiment, the AMF 150 may transmit to the SMF 160 a request message for moving PDU sessions determined to move a slice in step S415 to the target slice determined in step S425.

According to an embodiment, the request message transmitted by the AMF 150 may be referred to as an update session management request message. A message format of the request message transmitted by the AMF 150 may use at least one of “Nsmf_PDUSession_UpdateSMContext Request,” “Nsmf_PDUSession_ReleaseSMContext Request,” “Nsmf_PDUSession_UpdateSMContext Request,” and “Nsmf_PDUSession_ContextPushRequest,” According to an embodiment, the request message transmitted by the AMF 150 may include at least one of the following pieces of information.

“SM Context ID or PDU session ID,” “indication,” “Cause=OAM or congestion,” and “target slice information.”

However, according to various embodiments of the disclosure, the request message transmitted by the AMF 150 is not limited thereto, and may include information in addition to the aforementioned information.

“SM context ID” may be an identifier indicating per-session information. “Indication” may be set to at least one of three types of “context modification,” “release with make-before-break,” and “session release with break-before-make.”

According to an embodiment, the AMF 150 may not release the existing session, and may set “indication” to “context modification” when it is requested to modify only information on a slice of a corresponding session to the target slice through modification on the existing session.

According to an embodiment, when a PDU session corresponding to an SM context ID or a PDU session ID is an SSC mode 1 PDU session, the AMF 150 may set “indication” included in a message transmitted to the SMF 160 to “context modification.”

According to an embodiment, the AMF 150 may release the existing session established with an unavailable slice, and when it is requested to generate a new PDU session to a target slice for replacing a corresponding session, may set “indication” to “indication session release with break-before-make.”

According to an embodiment, before the existing session established with the unavailable slice is released, when it is requested to generate and then release a new PDU session to the target slice for replacing a corresponding session, the AMF 150 may set “indication” to “indication session release with make-before-break.”

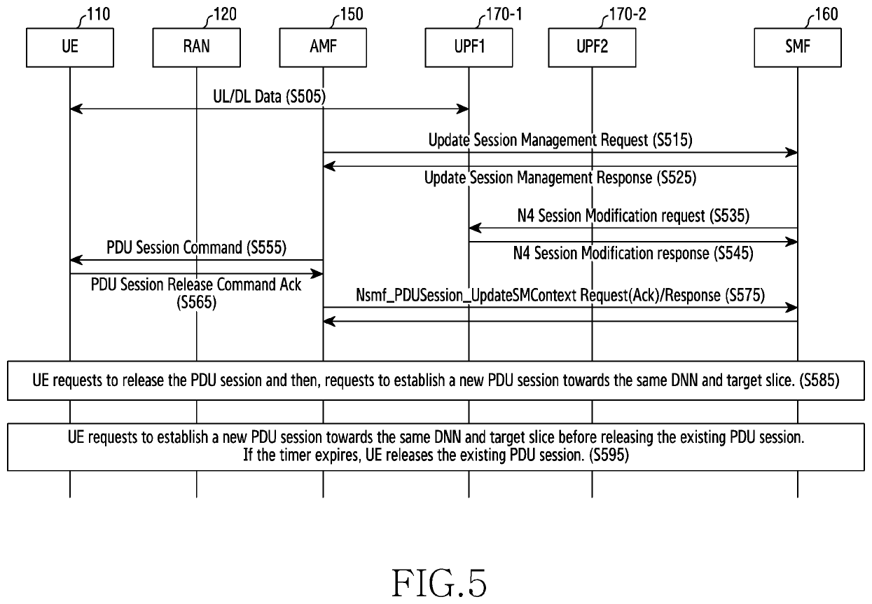

FIG. 5 illustrates a signaling flow for moving a slice for a session according to various embodiments of the present disclosure. Specifically, FIG. 5 illustrates a procedure of moving a slice for a session according to a received movement scheme, when the SMF 160 receives a slice movement request for the session from the AMF 160.

In step S515, the AMF 150 may transmit the request message to the SMF 160 to request to move a slice for a PDU session. A message format of the request message transmitted by the AMF 150 may use at least one of “Nsmf_PDUSession_UpdateSMContext Request,” “Nsmf_PDUSession_ReleaseSMContext Request,” “Nsmf_PDUSession_UpdateSMContext Request,” and “Nsmf_PDUSession_ContextPushRequest,” According to an embodiment, the request message transmitted by the AMF 150 may include at least one of the following pieces of information.

“SM Context ID or “PDU session ID,” “indication,” “Cause=OAM or congestion,” and “target slice information.”

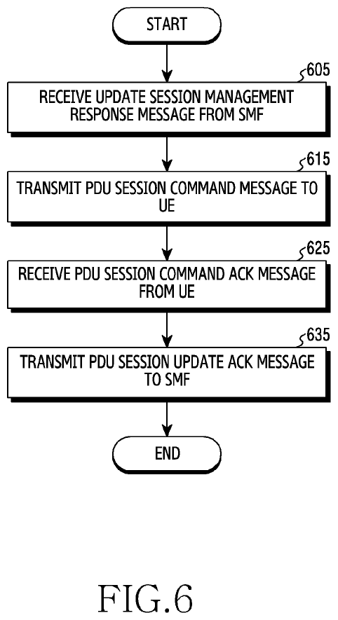

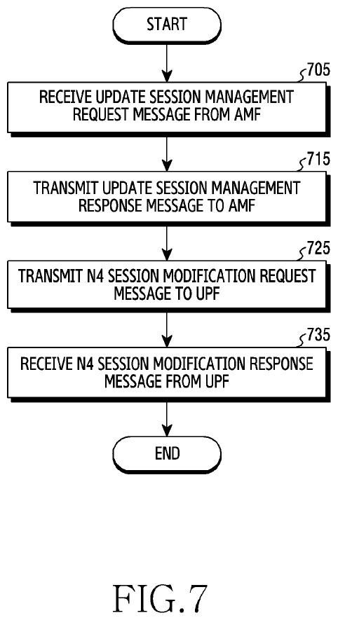

According to an embodiment, the SM context ID may be an identifier for a connection established between the SMF 160 and the AMF 150 for each PDU session. The targe slice information may include target slice (e.g., slice newly determined for a PDU session) identifier information (e.g., S-NSSAI). In this case, when a PDU session corresponding to the SM context ID or PDU session ID is a home-routed PDU session, the AMF 150 may forward the target slice information by including a visited public land mobile network (V-PLMN) S-NSSAI and home public land mobile network (H-PLMN) S-NSSAI for a target slice (e.g., a newly determined slice). Upon deriving the H-PLMN S-NSSAI, the AMF 150 may utilize slice mapping information between the H-PLMN and the V-PLMN. The aforementioned description may also be equally applied to various embodiments of FIG. 6 and FIG. 7.

According to an embodiment, when a PDU session corresponding to information included in the message received by the SMF 160 from the AMF 150 is a home-routed PDU session (e.g., a PDU session established through an H-SMF and H-UPF located in a home network) or when an H-PLMN S-NSSAI is included in the message received from the AMF 150, the SMF 160 may transmit a Nsmf_PDUSession_Update message to an H-SMF (not shown). The Nsmf_PDUSession_Update request message transmitted by the SMF 160 to the H-SMF may include information on at least one of H-SMF SM context ID, “indication,” “Cause=OAM or congestion, target slice information,” and target slice information including H-PLMN S-NSSAI information for a PDU session. When a UE is roaming and the PDU session is a home-routed PDU session, the H-SMF (not shown) may serve as the SMF 160 in a subsequent procedure, and the SMF 160 may forward to the AMF 150 a message received from the H-SMF (not shown). The aforementioned description may also be equally applied to various embodiments of FIG. 6 and FIG. 7.

However, according to various embodiments of the disclosure, the request message transmitted by the AMF 150 is not limited thereto, and may include information in addition to the aforementioned information.

As described with reference to FIG. 3, “SM context ID” may be an identifier indicating per-session information. “Indication” may be set to at least one of three types of “context modification,” “release with make-before-break,” and “session release with break-before-make.”

According to an embodiment, the AMF 150 may not release the existing session, and may set “indication” to “context modification” when it is requested to modify only information on a slice of a corresponding session to the target slice through modification on the existing session.

According to an embodiment, when a PDU session corresponding to an SM context ID or a PDU session ID is an SSC mode 1 PDU session, the AMF 150 may set “indication” included in a message transmitted to the SMF 160 to “context modification.”

According to an embodiment, the AMF 150 may release the existing session established with an unavailable slice, and when it is requested to generate a new PDU session to a target slice for replacing a corresponding session, may set “indication” to “session release with break-before-make.”

According to an embodiment, before the existing session established with the unavailable slice is released, when it is requested to generate and then release a new PDU session to the target slice for replacing a corresponding session, the AMF 150 may set “indication” to “session release with make-before-break.”

Referring to step S525, the SMF 160 may transmit a response message to the AMF 150, based on the request message received from the AMF 150.

Referring to step S525, when only the target slice exists in the reception message received from the AMF 150 in step S515, the SMF 160 may set the “indication” by considering an SSC mode for a PDU session, whether it is an MPS session, configuration information, UE subscriber information, or the like.

According to an embodiment, when a PDU session corresponding to the SM context ID or PDU session ID included in the message received from the AMF 150 is an SSC mode 1 PDU session (e.g., a PDU session requiring not to change a UPF for the PDU session), the AMF 150 may set “indication” included in a message transmitted to the SMF 160 to “context modification,” According to an embodiment, if the SMF 160 sets “indication” to “context modification,” the AMF 150 may determine to change only information on a slice of a corresponding session through modification on the existing session, without having to release the existing session.

According to an embodiment, when a PDU session corresponding to the SM context ID or PDU session ID included in the message received by the SMF 160 from the AMF 150 is an SSC mode 2 or an SSC mode 3, “indication” may be set to “context modification.”

According to an embodiment, when a PDU session corresponding to the SM context ID or PDU session ID included in the message received by the SMF 160 from the AMF 150 is the SSC mode 1 PDU session, “indication” may not be set to “session release with make-before-break” or “session release with break-before-make.”

If there is no target slice in the reception message received from the AMF 150 in step S515, the SMF 160 may determine the target slice through configuration information or interaction with the AMF 150.

According to an embodiment, upon determining to move to the target slice, the SMF 160 may transmit a response message to the AMF 150. The response message transmitted by the SMF 160 may include information on the target slice. The response message transmitted by the SMF 160 may be referred to as an update session management response message.

Referring to step S525, when the “indication” of the request message received from the AMF 150 is “context modification,” the response message transmitted to the AMF 150 may include the following information.

“SM Context ID or PDU session ID,” “target slice,” “N2 SM container(‘SM Context ID or PDU session ID,’ ‘target slice,’ ‘cause=OAM or congestion,’ and ‘N1 SM Container’).”

The following information may be included in the “N1 SM container.”

“PDU session modification command (“PDU Session ID,” ‘target slice’).”

For example, according to an embodiment, when a PDU session corresponding to the SM context ID or PDU session ID included in the message received by the SMF 160 from the AMF 150 is the SSC mode 1 PDU session, a message transmitted by the SMF 160 to the UE 110 may include information indicating to change an S-NSSAI (a slice identifier) for the PDU session. According to an embodiment, the N1 SM container message may include different information capable of identifying the PDU session in addition to the PDU session ID.

However, according to various embodiments of the disclosure, the response message transmitted by the SMF 160 is not limited thereto, and may include information in addition to the aforementioned information.

Referring to step S525, when the “indication” of the request message received from the AMF 150 is “session release with break-before-make” or “session release with make-before-break,” the message transmitted to the AMF 150 may including the following information.

“SM Context ID or PDU session ID,” “N2 SM container(“SM Context ID or PDU session ID,” “target slice,” “cause=OAM or congestion,” and “N1 SM Container”).

According to an embodiment, when the “indication” of the message received by the SMF 160 is “session release with break-before-make,” the following information may be included in the “N1 SM container.”

“PDU Session Release Command”(“PDU Session ID,” “target slice,” “session re-establishment request to the same DN,” “target slice indication”).

According to an embodiment, when the “indication” of the message received by the SMF 160 is “session release with make-before-break,” the following information may be included in the “N1 SM container.”

PDU session modification command (“PDU Session ID,” “target slice,” “session re-establishment request to the same DN,” “target slice indication,” “[PDU session release timer]”).

According to an embodiment, the SMF 160 may perform steps S535 and S545 after receiving an acknowledgement (Ack) message for a PDU session modification command from the UE in step S575.

Referring to step S535, when a PDU session identifier (or a PDU session context ID) and “indication” set to “context modification” are included in the request message received from the AMF 150, the SMF 160 may transmit an N4 session modification request message to the UPF 170 to change slice information of the N4 session to a target slice. An N4 interface (for example, an N4 reference point) may be an interface constructed between the SMF 160 and the UPF 170. The N4 session modification request message transmitted by the SMF 160 to the UPF 170 may include at least one of an N4 session context ID, information on a target slice, an indicator indicating that it is a slice change request, and information indicating a slice change cause.

Referring to step S545, the UPF 170 may transmit the N4 session modification response message to the SMF 160, based on the received N4 session modification request message. The N4 session modification response message transmitted by the UPF 170 to the SMF 160 may include at least one of an N4 session context ID and information on a result. Upon receiving from the UPF 170 a response message indicating that a slice is successfully modified, the SMF 160 may change slice information of an N4 session to a target slice. According to an embodiment of the disclosure, the UPF 170 and the SMF 160 may determine and perform whether to change the N4 interface through a process of steps S535 and S545.

Referring to step S555, when the target slice is included in the message received from the SMF 160 in step S525, the AMF 150 may change slice information on a session to the target slice, in information stored for a session corresponding to the SM context ID or PDU session ID. In addition, in step S555, the AMF 150 may forward information included in the N2 SM container to the RAN 120. When the target slice is included in the message received from the AMF, the RAN 120 may change slice information on a session to the target slice, in information stored for a session corresponding to the received SM context ID or PDU session ID. The RAN 120 may forward the N1 SM container to the UE 110. The aforementioned series of processes are not limited thereto, and the aforementioned flow of messages transmitted from the AMF 150 to the UE 110 via the RAN 120 may be represented by transmission of PDU session command message information as illustrated in FIG. 5.

Referring to step S565, when the message received from the RAN 120 in step S555 includes “PDU session ID” and “target slice,” the UE 110 may change slice information on a session to the target slice, in information stored for a session corresponding to the received PDU session ID.

Referring to steps S565 and S575, the UE 110 may forward a message for acknowledging that information on a session has been changed to the SMF via the RAN 120 and the AMF 150. In the aforementioned forwarding process, the RAN 120 and the AMF 150 may forward to the SMF 160 a message including the message for acknowledging that information on each session has been changed. The aforementioned series of processes are not limited thereto, and the aforementioned flow of signals transmitted from the UE 110 to the AMF 150 via the RAN 120 may be represented by transmission of a PDU session release command Ack message (or an Ack message for the PDU session modification command) as illustrated in FIG. 5. In addition, a flow of signals transmitted from the AMF 150 to the SMF 160 may be represented by transmission of a PDU session update request Ack message as illustrated in FIG. 5.

According to an embodiment, in step S575, the SMF 160 may perform steps S535 and 5545 after receiving an Ack message for the PDU session modification command from the UE.

Referring to step S585, when the message received from the RAN 120 in step S555 includes “PDU session ID,” “target slice,” “session re-establishment request to the same DN,” or “target slice indication,” the UE 110 may transmit the received PDU session ID to the SMF 160 via the AMF 150 by including it in the PDU session release request message, and may request to release a PDU session corresponding to the received PDU session.

According to an embodiment, the UE 110 may request for a new PDU session by forwarding a data network name (DNN) such as a PDU session in which a release request is performed and the target slice received in step S555 to the SMF 160 by including them in the PDU session generation request message. When a new session is generated with the target slice, the UE 110 may transmit traffic flows, which have been transmitted with a released PDU session, through the new PDU session.

Referring to step S595, when the message received from the RAN 120 in step S555 includes “PDU session ID,” “target slice,” “session re-establishment request to the same DN,” “target slice indication,” or “PDU session release timer,” the UE 110 may request for a new PDU session by forwarding a DNN such as a PDU session corresponding to the received PDU session ID and the target slice received in step S555 to the SMF 160 by including them in the PDU session generation request message. When a new session is generated with the target slice, the UE 110 may transmit traffic flows, which have been transmitted with the existing PDU session, through the generated new PDU session.

According to an embodiment, after the new PDU session is generated, when a received PDU session release timer expires or due to internal configuration of the UE, the UE 110 may transmit the receive PDU session ID to the SMF 160 via the AMF 150 by including it in the PDU session release request message. The UE 110 may request to release a PDU session corresponding to the received PDU session ID by transmitting a message to the SMF 160.

FIG. 6 is a flowchart illustrating an operation of the AMF 150 for moving a slice for a session according to various embodiments of the present disclosure. Specifically, an operational flow of the AMF 150 illustrated in FIG. 6 may operate based on the signal flowchart illustrated in FIG. 5.

Referring to step 605, the AMF 150 may receive an update session management response message from the SMF 160. Specifically, the AMF 150 may receive from the SMF 160 a response message generated based on the request message transmitted to the SMF 160. According to an embodiment, the response message received by the AMF 150 may include information on the target slice.

When the “indication” of the request message received by the SMF 160 is “context modification,” the response message received by the AMF 150 may include the following information.

“SM Context ID or PDU session ID,” “target slice,” “N2 SM container(“SM Context ID or PDU session ID,” “target slice,” and “cause=OAM or congestion,” and “N1 SM Container’).”

The following information may be included in the “N1 SM container,”

“PDU session modification command (‘PDU Session ID,’ target slice').”

For example, according to an embodiment, when a PDU session corresponding to the SM context ID or PDU session ID included in the message received by the SMF 160 from the AMF 150 is an SSC mode 1 PDU session, a message transmitted by the SMF 160 to the UE 110 may include information indicating to change an S-NSSAI (a slice identifier) for the PDU session. According to an embodiment, the N1 SM container message may include different information capable of identifying the PDU session in addition to the PDU session ID.

However, according to various embodiments of the disclosure, the response message receive by the AMF 150 is not limited thereto, and may include information in addition to the aforementioned information.

According to an embodiment, when the “indication” of the request message received by the SMF 160 is “session release with break-before-make” or “session release with make-before-break,” the message received by the AMF 150 may include the following information.

“SM Context ID or PDU session ID,” “N2 SM container(‘SM Context ID or PDU session ID,’ ‘target slice,’ ‘cause=OAM or congestion,’ and ‘N1 SM Container’).”

According to an embodiment, when the “indication” of the message received by the SMF 150 is “session release with break-before-make,” the following information may be included in the “N1 SM container.”

“PDU Session Release Command”(“PDU Session ID,” “target slice,” “session re-establishment request to the same DN,” “target slice indication”).

According to an embodiment, when the “indication of the message received by the SMF 160 is “session release with make-before-break,” the following information may be included in the “N1 SM container.”

PDU session modification command (“PDU Session ID,” “target slice,” “session re-establishment request to the same DN,” “target slice indication,” “[PDU session release timer]”).

Referring to step 615, the AMF 150 may transmit a message including PDU session command information to the UE 110. A process in which the AMF 150 transmits the PDU session command message to the UE 110 according to various embodiments of the disclosure may include at least one of a process in which the AMF 150 transmits information included in the N2 SM container to the RAN 120 and a process in which the RAN 120 transmits information included in the N1 SM container to the UE 110.

According to an embodiment, when the response message received from the SMF 160 includes the target slice, the AMF 150 may change slice information on a session to the target slice, in information stored for a session corresponding to the SM context ID or PDU session ID. In addition, the AMF 150 may forward information included in the N2 SM container to the RAN 120. When the target slice is included in the message received from the AMF, the RAN 120 may change slice information on a session to the target slice, in information stored for a session corresponding to the received SM context ID or PDU session ID. The RAN 120 may forward the N1 SM container to the UE 110. The aforementioned series of processes are not limited thereto, and the aforementioned flow of signals transmitted from the AMF 150 to the UE 110 via the RAN 120 may be represented by transmission of a PDU session command message as illustrated in FIG. 5.

Referring to step 625, the AMF 150 may receive a PDU session command Ack message from the UE 110. According to an embodiment, when the message received from the RAN 120 includes “PDU session ID” and “target slice,” the UE 110 may change slice information on a session to the target slice, in information stored for a session corresponding to the received PDU session ID. The AMF 150 may receive from the UE 110 via the RAN 120 a message for acknowledging whether information on a session has been changed. The aforementioned series of processes are not limited thereto, and the aforementioned flow of signals transmitted from the UE 110 to the AMF 150 via the RAN 120 may be represented by transmission of a PDU session release command Ack message (or an Ack message for the PDU session modification command) as illustrated in FIG. 5.

According to an embodiment, when the message received by the UE 110 from the RAN 120 includes “PDU session ID,” “target slice,” “session re-establishment request to the same DN,” or “target slice indication,” the AMF 150 may receive a PDU session release request message including the received PDU session ID. According to an embodiment, the AMF 150 may receive from the UE 110 a data network name (DNN) such as a PDU session in which the UE 110 performs a release request performed and a PDU session generation request message including a target slice received by the UE 110 from the RAN 120.

According to an embodiment, when the message received by the UE 110 from the RAN 120 includes “PDU session ID,” “target slice,” “session re-establishment request to the same DN,” “target slice indication,” or “PDU session release timer,” the AMF 150 may receive a data network name (DNN) such as a PDU session corresponding to the received PDU session ID and a PDU session generation request message including a target slice received by the UE 110. According to an embodiment, after the UE 110 generates the new PDU session, when a received PDU session release timer expires or due to internal configuration of the UE, the AMF 150 may receive from the UE 110 a PDU session release request message including the received PDU session ID.

Referring to step 635, the AMF 150 may transmit a PDU session update Ack message to the SMF 160. In addition, a flow of signals transmitted from the AMF 150 to the SMF 160 may be represented by transmission of a PDU session update request Ack message as illustrated in FIG. 5.

According to an embodiment, the AMF 150 may transmit to the SMF 160 the PDU session release request message received from the UE 110. According to an embodiment, the AMF 150 may transmit to the SMF 160 the PDU session generate request message received from the UE 110.

FIG. 7 is a flowchart illustrating an operation of an SMF for moving a slice for a session according to various embodiments of the present disclosure. Specifically, an operational flow of the SMF 160 of FIG. 7 may operate based on the signal flow illustrated in FIG. 5.

In step 705, the SMF 160 may receive an update session management request message from the AMF 150. A message format of the request message received by the SMF 160 may use at least one of “Nsmf_PDUSession_UpdateSMContext Request,” “Nsmf_PDUSession_ReleaseSMContext Request,” “Nsmf_PDUSession_UpdateSMContext Request,” and “Nsmf_PDUSession_ContextPushRequest.” According to an embodiment, the request message transmitted by the AMF 150 may include at least one of the following pieces of information.

“SM Context ID” or “PDU session ID,” “indication,” “Cause=OAM or congestion,” and “target slice information.”

However, according to various embodiments of the disclosure, the request message received by the SMF 160 is not limited thereto, and may include information in addition to the aforementioned information.

As described with reference to FIG. 3, “SM context ID” may be an identifier indicating per-session information. “Indication” may be set to at least one of three types of “context modification,” “release with make-before-break,” and “session release with break-before-make.”

According to an embodiment, the AMF 150 which transmits a request message may not release the existing session, and may set “indication” to “context modification” when it is requested to modify only information on a slice of a corresponding session to the target slice through modification on the existing session.

According to an embodiment, when a PDU session corresponding to an SM context ID or a PDU session ID is an SSC mode 1 PDU session, the AMF 150 may set “indication” included in a message transmitted to the SMF 160 to “context modification.”

According to an embodiment, when the existing session established with the unavailable slice is released and when it is requested to generate a new PDU session to the target slice for replacing a corresponding session, the AMF 150 which transmits a request message may set “indication” to “session release with break-before-make.”

According to an embodiment, before the existing session established with the unavailable slice is released, when it is requested to generate and then release a new PDU session to the target slice for replacing a corresponding session, the AMF 150 which transmits a request message may set “indication” to “session release with make-before-break.”

In step 715, the SMF 160 may transmit an update session management response message to the AMF 150. When only the target slice exists in the reception message received from the AMF 150 in step 705, the SMF 160 may set the “indication” by considering an SSC mode for a PDU session, whether it is an MPS session, configuration information, UE subscriber information, or the like.

According to an embodiment, when a PDU session corresponding to the SM context ID or PDU session ID included in the message received from the AMF 150 is an SSC mode 1 PDU session (e.g., a PDU session requiring not to change a UPF for the PDU session), the AMF 150 may set “indication” included in a message transmitted to the SMF 160 to “context modification,” According to an embodiment, if the SMF 160 sets “indication” to “context modification,” the AMF 150 may determine to change only information on a slice of a corresponding session through modification on the existing session, without having to release the existing session.

According to an embodiment, when a PDU session corresponding to the SM context ID or PDU session ID included in the message received by the SMF 160 from the AMF 150 is an SSC mode 2 or an SSC mode 3, “indication” may be set to “context modification,”

According to an embodiment, when a PDU session corresponding to the SM context ID or PDU session ID included in the message received by the SMF 160 from the AMF 150 is the SSC mode 1 PDU session, “indication” may not be set to “session release with make-before-break” or “session release with break-before-make.”

If there is no target slice in the reception message received from the AMF 150 in step 705, the SMF 160 may determine the target slice through configuration information or interaction with the AMF 150.

According to an embodiment, upon determining to move to the target slice, the SMF 160 may transmit a response message to the AMF 150. The response message transmitted by the SMF 160 may include information on the target slice. The response message transmitted by the SMF 160 may be referred to as an update session management response message.

Referring to step 715, when the “indication” of the request message received from the AMF 150 is “context modification,” the response message transmitted to the AMF 150 may include the following information.

“SM Context ID or PDU session ID,” “target slice,” “N2 SM container(“SM Context ID or PDU session ID,” “target slice,” “cause=OAM or congestion,” and “N1 SM Container”).

The following information may be included in the “N1 SM container.”

“PDU session modification command (‘PDU Session ID,’ ‘target slice’).”

For example, according to an embodiment, when a PDU session corresponding to the SM context ID or PDU session ID included in the message received by the SMF 160 from the AMF 150 is the SSC mode 1 PDU session, a message transmitted by the SMF 160 to the UE 110 may include information indicating to change an S-NSSAI (a slice identifier) for the PDU session. According to an embodiment, the N1 SM container message may include different information capable of identifying the PDU session in addition to the PDU session ID.

However, according to various embodiments of the disclosure, the response message transmitted by the SMF 160 is not limited thereto, and may include information in addition to the aforementioned information.

Referring to step 715, when the “indication” of the request message received from the AMF 150 is “session release with break-before-make” or “session release with make-before-break,” the message transmitted to the AMF 150 may include the following information.

“SM Context ID or PDU session ID,” “N2 SM container(‘SM Context ID or PDU session ID,’ ‘target slice,’ ‘cause=OAM or congestion,’ and ‘N1 SM Container’).”

According to an embodiment, when the “indication” of the message received by the SMF 160 is “session release with break-before-make,” the following information may be included in the “N1 SM container.”

“PDU Session Release Command”(“PDU Session ID,” “target slice,” “session re-establishment request to the same DN,” “target slice indication”).

According to an embodiment, when the “indication” of the message received by the SMF 160 is “session release with make-before-break,” the following information may be included in the “N1 SM container.”

PDU session modification command (“PDU Session ID,” “target slice,” “session re-establishment request to the same DN,” “target slice indication,” “[PDU session release timer]”).

In step 725, the SMF may transmit an N4 session modification request message to the UPF. Referring to step 725, when a PDU session identifier (or a PDU session context ID) and “indication” set to “context modification” are included in the request message received from the AMF 150, the SMF 160 may transmit the N4 session modification request message to the UPF 170. An N4 interface (for example, an N4 reference point) may be an interface constructed between the SMF 160 and the UPF 170. The N4 session modification request message transmitted by the SMF 160 to the UPF 170 may include at least one of an N4 session context ID, information on a target slice, an indicator indicating that it is a slice change request, and information indicating a slice change cause.

In step 735, the SMF may receive an N4 session modification response message from the UPF. Referring to step 735, the UPF 170 may transmit the N4 session modification response message to the SMF 160, based on the received N4 session modification request message. The N4 session modification response message transmitted by the UPF 170 to the SMF 160 may include at least one of an N4 session context ID and information on a result. Upon receiving from the UPF 170 a response message indicating that a slice is successfully modified, the SMF 160 may change slice information of an N4 session to a target slice. According to an embodiment of the disclosure, the UPF 170 and the SMF 160 may determine and perform whether to change the N4 interface through a process of steps S535 and S545.

According to various embodiments, a method performed by an access mobility and management function (AMF) node in a mobile communication system, the method comprising: receiving, from a slice availability check function (SACF) node, a notification message including information on an unavailable slice; receiving, from a network data analysis function (NWDAF) node, information on a protocol data unit (PDU) session; determining, based on the notification message and the information on the PDU session, a target slice and at least one PDU session requiring a change of slice; and transmitting, to a session management function (SMF) node, a request message for changing the slice of the at least one PDU session to the target slice.

In one embodiment, wherein the request message includes information on the target slice and an indication indicating a changing method for the at least one PDU session, and wherein the changing method comprises at least one of a first method of modifying a context of the at least one PDU session, a second method of establishing one or more PDU sessions after releasing the at least one PDU session, or a third method of releasing the at least one PDU session after establishing the one or more PDU sessions.

In one embodiment, in case that the changing method is the first method, further comprising: receiving, from the SMF node, a modification command of the at least one PDU session; and transmitting, to a user equipment, the modification command of the at least one PDU session.

In one embodiment, in case that the changing method is the second method, further comprising: receiving, from the SMF node, a release command of the at least one PDU session including information for generating the one or more PDU session; and transmitting, to a user equipment, the release command of the at least one PDU session.

In one embodiment, in case that the changing method is the third method, further comprising: receiving, from the SMF node, a modification command of the at least one PDU session including information for generating the one or more PDU session and a timer for releasing the at least one PDU session; and transmitting, to a user equipment, the modification command of the at least one PDU session.

In one embodiment, wherein the notification message further includes slice change required information, and wherein the slice change required information includes at least one of an indication indicating slice change for the unavailable slice or information on a target slice for each unavailable slice.

In one embodiment, wherein the first method corresponds to session and service continuity (SSC) mode 1, wherein the second method corresponds to SSC mode 2, and wherein the third method corresponds to SSC mode 3.

In one embodiment, in case that the at least one PDU session is home-routed PDU session, further comprising: generating a home (H)-public land mobile network (PLMN) single-network slice selection assistance (S-NSSAI) for the target slice based on a mapping information between a H-PLMN and a V (visited)-PLMN; and transmitting, to the SMF node, the generated H-PLMN S-NSSAI.

According to various embodiments, a method performed by a session management function (SMF) node in a mobile communication system, the method comprising: receiving, from an access mobility and management function (AMF) node, a request message for changing a slice of at least one protocol data unit (PDU) session; and transmitting, to the AMF node, information on a change of the at least one PDU session based on the request message, wherein the request message includes information on the target slice and an indication indicating a changing method for the at least one PDU session, and wherein the changing method comprises at least one of a first method of modifying a context of the at least one PDU session, a second method of establishing one or more PDU sessions after releasing the at least one PDU session, or a third method of releasing the at least one PDU session after establishing the one or more PDU sessions.

In one embodiment, in case that the changing method is the first method, further comprising: transmitting, to a user plane function (UPF) node, an N4 session modification request message for changing information on a slice of an N4 session into information on the target slice.

According to various embodiments, an access mobility and management function (AMF) node in a mobile communication system, the AMF comprising a controller, wherein the controller is configured to: receive, from a slice availability check function (SACF) node, a notification message including information on an unavailable slice, receive, from a network data analysis function (NWDAF) node, information on a protocol data unit (PDU) session, determine, based on the notification message and the information on the PDU session, a target slice and at least one PDU session requiring a change of slice, and transmit, to a session management function (SMF) node, a request message for changing the slice of the at least one PDU session to the target slice.

In one embodiment, wherein the request message includes information on the target slice and an indication indicating a changing method for the at least one PDU session, and wherein the changing method comprises at least one of a first method of modifying a context of the at least one PDU session, a second method of establishing one or more PDU sessions after releasing the at least one PDU session, or a third method of releasing the at least one PDU session after establishing the one or more PDU sessions.

In one embodiment, in case that the changing method is the first method, wherein the controller is further configured to: receive, from the SMF node, a modification command of the at least one PDU session, and transmit, to a user equipment, the modification command of the at least one PDU session.

In one embodiment, in case that the changing method is the second method, wherein the controller is further configured to: receive, from the SMF node, a release command of the at least one PDU session including information for generating the one or more PDU session, and transmit, to a user equipment, the release command of the at least one PDU session.

In one embodiment, in case that the changing method is the third method, wherein the controller is further configured to: receive, from the SMF node, a modification command of the at least one PDU session including information for generating the one or more PDU session and a timer for releasing the at least one PDU session, and transmit, to a user equipment, the modification command of the at least one PDU session.

In one embodiment, wherein the notification message further includes slice change required information, and wherein the slice change required information includes at least one of an indication indicating slice change for the unavailable slice or information on a target slice for each unavailable slice.

In one embodiment, wherein the first method corresponds to session and service continuity (SSC) mode 1, wherein the second method corresponds to SSC mode 2, and wherein the third method corresponds to SSC mode 3.

In one embodiment, in case that the at least one PDU session is home-routed PDU session, wherein the controller is further configured to: generate a home (H)-public land mobile network (PLMN) single-network slice selection assistance (S-NSSAI) for the target slice based on a mapping information between a H-PLMN and a V (visited)-PLMN, and transmit, to the SMF node, the generated H-PLMN S-NSSAI.

According to various embodiments, a session management function (SMF) node in a mobile communication system, the SMF comprising a controller, wherein the controller is configured to: receive, from an access mobility and management function (AMF) node, a request message for changing a slice of at least one protocol data unit (PDU) session, and transmit, to the AMF node, information on a change of the at least one PDU session based on the request message, wherein the request message includes information on the target slice and an indication indicating a changing method for the at least one PDU session, and wherein the changing method comprises at least one of a first method of modifying a context of the at least one PDU session, a second method of establishing one or more PDU sessions after releasing the at least one PDU session, or a third method of releasing the at least one PDU session after establishing the one or more PDU sessions.

In one embodiment, in case that the changing method is the first method, wherein the controller is further configured to: transmit, to a user plane function (UPF) node, an N4 session modification request message for changing information on a slice of an N4 session into information on the target slice.

Methods based on the embodiments disclosed in the claims and/or specification of the disclosure may be implemented in hardware, software, or a combination of both.

When implemented in software, computer readable recording medium for storing one or more programs (i.e., software modules) may be provided. The one or more programs stored in the computer readable recording medium are configured for execution performed by one or more processors in the electronic device. The one or more programs include instructions for allowing the electronic device to execute the methods based on the embodiments disclosed in the claims and/or specification of the disclosure.

The program (i.e., the software module or software) may be stored in a random access memory, a non-volatile memory including a flash memory, a read only memory (ROM), an electrically erasable programmable read only memory (EEPROM), a magnetic disc storage device, a compact disc-ROM (CD-ROM), digital versatile discs (DVDs) or other forms of optical storage devices, and a magnetic cassette. Alternatively, the program may be stored in a memory configured in combination of all or some of these storage media. In addition, the configured memory may be plural in number.

Further, the program may be stored in an attachable storage device capable of accessing the electronic device through a communication network such as the Internet, an Intranet, a local area network (LAN), a wide LAN (WLAN), or a storage area network (SAN) or a communication network configured by combining the networks. The storage device may have access to a device for performing an embodiment of the disclosure via an external port. In addition, an additional storage device on a communication network may have access to the device for performing the embodiment of the disclosure.

In the aforementioned specific embodiments of the disclosure, a component included in the disclosure is expressed in a singular or plural form according to the specific embodiment provided herein. However, the singular or plural expression is selected properly for a situation provided for the convenience of explanation, and thus the various embodiments of the disclosure are not limited to a single or a plurality of components. Therefore, a component expressed in a plural form may also be expressed in a singular form, or vice versa.

While the disclosure has been shown and described with reference to certain preferred embodiments thereof, it will be understood by those skilled in the art that various changes in form and details may be made therein without departing from the spirit and scope of the disclosure as defined by the appended claims. Therefore, the scope of the disclosure is defined not by the detailed description thereof but by the appended claims, and all differences within equivalents of the scope will be construed as being included in the disclosure.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by an access mobility and management function (AMF) node in a mobile communication system, the method comprising:
receiving, from a slice availability check function (SACF) node, a notification message including information for an unavailable slice;
receiving, from a network data analysis function (NWDAF) node, information for a protocol data unit (PDU) session;
determining, based on the notification message and the information for the PDU session, a target slice and at least one PDU session requiring a change of slice; and
transmitting, to a session management function (SMF) node, a request message for changing the slice of the at least one PDU session to the target slice.

2. The method of claim 1, wherein the request message includes information for the target slice and an indication indicating a changing scheme for the at least one PDU session, and
wherein the changing scheme comprises at least one of a first scheme for modifying context of the at least one PDU session, a second scheme for establishing one or more PDU sessions after releasing the at least one PDU session, or a third scheme for releasing the at least one PDU session after establishing the one or more PDU sessions.

3. The method of claim 2, in case that the changing scheme is the first scheme, further comprising:
receiving, from the SMF node, a modification command of the at least one PDU session; and
transmitting, to a user equipment, the modification command of the at least one PDU session.

4. The method of claim 2, in case that the changing scheme is the second scheme, further comprising:
receiving, from the SMF node, a release command of the at least one PDU session including information for generating the one or more PDU session; and
transmitting, to a user equipment, the release command of the at least one PDU session.

5. The method of claim 2, in case that the changing scheme is the third scheme, further comprising:
receiving, from the SMF node, a modification command of the at least one PDU session including information for generating the one or more PDU session and a timer for releasing the at least one PDU session; and
transmitting, to a user equipment, the modification command of the at least one PDU session.

6. The method of claim 1, wherein the notification message further includes slice change required information, and
wherein the slice change required information includes at least one of an indication indicating slice change for the unavailable slice or information for a target slice for each unavailable slice.

7. The method of claim 2, wherein the first scheme corresponds to a session and service continuity (SSC) mode 1,
wherein the second scheme corresponds to an SSC mode 2, and
wherein the third scheme corresponds to an SSC mode 3.

8. The method of claim 1, in case that the at least one PDU session is a home-routed PDU session, further comprising:
generating a home (H)-public land mobile network (PLMN) single-network slice selection assistance (S-NSSAI) for the target slice based on mapping information between a H-PLMN and a V (visited)-PLMN; and
transmitting, to the SMF node, the generated H-PLMN S-NSSAI.

9. A method performed by a session management function (SMF) node in a mobile communication system, the method comprising:
receiving, from an access mobility and management function (AMF) node, a request message for changing a slice of at least one protocol data unit (PDU) session; and
transmitting, to the AMF node, information for a change of the at least one PDU session based on the request message,
wherein the request message includes information for a target slice and an indication indicating a changing scheme for the at least one PDU session, and
wherein the changing scheme comprises at least one of a first scheme for modifying context of the at least one PDU session, a second scheme for establishing one or more PDU sessions after releasing the at least one PDU session, or a third scheme for releasing the at least one PDU session after establishing the one or more PDU sessions.

10. The method of claim 9, in case that the changing scheme is the first scheme, further comprising:
transmitting, to a user plane function (UPF) node, an N4 session modification request message for changing information for a slice of an N4 session into information for the target slice.

11. An access mobility and management function (AMF) node in a mobile communication system, the AMF comprising:
a controller configured to:
receive, from a slice availability check function (SACF) node, a notification message including information for an unavailable slice,
receive, from a network data analysis function (NWDAF) node, information for a protocol data unit (PDU) session,
determine, based on the notification message and the information for the PDU session, a target slice and at least one PDU session requiring a change of slice, and
transmit, to a session management function (SMF) node, a request message for changing the slice of the at least one PDU session to the target slice.

12. The AMF node of claim 11, wherein the request message includes information for the target slice and an indication indicating a changing scheme for the at least one PDU session, and
wherein the changing scheme comprises at least one of a first scheme for modifying context of the at least one PDU session, a second scheme for establishing one or more PDU sessions after releasing the at least one PDU session, or a third scheme for releasing the at least one PDU session after establishing the one or more PDU sessions.

13. The AMF node of claim 12, in case that the changing scheme is the first scheme, wherein the controller is further configured to:
receive, from the SMF node, a modification command of the at least one PDU session, and
transmit, to a user equipment, the modification command of the at least one PDU session.

14. The AMF node of claim 12, in case that the changing scheme is the second scheme, wherein the controller is further configured to:
receive, from the SMF node, a release command of the at least one PDU session including information for generating the one or more PDU session, and
transmit, to a user equipment, the release command of the at least one PDU session.

15. The AMF node of claim 12, in case that the changing scheme is the third scheme, wherein the controller is further configured to:
receive, from the SMF node, a modification command of the at least one PDU session including information for generating the one or more PDU session and a timer for releasing the at least one PDU session, and
transmit, to a user equipment, the modification command of the at least one PDU session.

16. The AMF node of claim 11, wherein the notification message further includes slice change required information, and
wherein the slice change required information includes at least one of an indication indicating slice change for the unavailable slice or information for the target slice for each unavailable slice.

17. The AMF node of claim 12, wherein the first scheme corresponds to a session and service continuity (SSC) mode 1,
wherein the second scheme corresponds to an SSC mode 2, and
wherein the third scheme corresponds to an SSC mode 3.

18. The AMF node of claim 11, in case that the at least one PDU session is a home-routed PDU session, wherein the controller is further configured to:
generate a home (H)-public land mobile network (PLMN) single-network slice selection assistance (S-NSSAI) for the target slice based on mapping information between a H-PLMN and a V (visited)-PLMN; and
transmit, to the SMF node, the generated H-PLMN S-NSSAI.

19. A session management function (SMF) node in a mobile communication system, the SMF comprising:
a controller configured to:
receive, from an access mobility and management function (AMF) node, a request message for changing a slice of at least one protocol data unit (PDU) session, and
transmit, to the AMF node, information for a change of the at least one PDU session based on the request message,
wherein the request message includes information for a target slice and an indication indicating a changing scheme for the at least one PDU session, and
wherein the changing scheme comprises at least one of a first scheme for modifying context of the at least one PDU session, a second scheme for establishing one or more PDU sessions after releasing the at least one PDU session, or a third method of releasing the at least one PDU session after establishing the one or more PDU sessions.

20. The SMF node of claim 19, in case that the changing scheme is the first scheme, wherein the controller is further configured to:
transmit, to a user plane function (UPF) node, an N4 session modification request message for changing information for a slice of an N4 session into information for the target slice.
